(19) United States
(12) Patent Application Publication
(10) Pub. No.: US 2009/0254274 A1
(43) Pub. Date: Oct. 8, 2009

(54) NAVIGATION SYSTEM FOR PROVIDING CELESTIAL AND TERRESTRIAL INFORMATION

(76) Inventors: Victor Kulik, Claremont, CA (US); Anatole M. Lokshin, Huntington Beach, CA (US)

Correspondence Address: GREENBERG TRAURIG, LLP (SV3), IP DOCKETING, 2450 COLORADO AVENUE SUITE 400E, SANTA MONICA, CA, 90404, US

(21) Appl. No.: 11/829,856

(22) Filed: Jul. 27, 2007

(51) Int. Cl. G01C 21/00

(52) U.S. Cl. 701/213; 701/200

(57) ABSTRACT

A device for viewing celestial and terrestrial data having a housing with a reference axis, a database disposed in the housing and containing celestial and terrestrial data, a GPS receiver operatively coupled to the database and configured to receive a GPS signal, a processor operatively coupled to the GPS receiver and the database and configured to determine a user's location from the GPS signal, a sensor operatively coupled to the processor and adapted to provide the processor with a rotational angle representing the orientation of the housing relative to the reference axis, and a display unit operatively coupled to the processor and displays celestial and/or terrestrial data to the user corresponding to the rotational angle of the housing.

### BACKGROUND

1. Field

This disclosure relates generally to a navigation system. More particularly, the disclosure relates to a navigation system for displaying celestial and terrestrial information.

2. General Background

Current navigation systems are used for providing terrestrial information. Using a Global Positioning System (GPS), the navigation systems can determine the location of the system, and compute directions to navigate to a desired location. For example, prior art vehicle navigation systems can compute a route to a desired location and display the route on a display panel. The navigation system can allow a user to zoom in and out of the displayed route and/or view other terrestrial information independent of the vehicle's location.

### SUMMARY

The present invention provides a device for viewing celestial and terrestrial data having a housing with a reference axis, a database disposed in the housing and containing celestial and terrestrial data, a GPS receiver operatively coupled to the database and configured to receive a GPS signal, a processor operatively coupled to the GPS receiver and the database and configured to determine a user's location from the GPS signal, a sensor operatively coupled to the processor and adapted to provide the processor with a rotational angle representing the orientation of the housing relative to the reference axis, and a display unit operatively coupled to the processor and displays celestial and/or terrestrial data to the user corresponding to the rotational angle of the housing.

In one embodiment, the device for viewing celestial and terrestrial data includes a database containing celestial and terrestrial data, a processor operatively coupled to the database, the processor is configured to determine celestial and terrestrial data corresponding to at least one coordinate entry, an input device operatively coupled to the processor, the input device provides an interface for inputting the at least one coordinate entry, and a display unit operatively coupled to the processor, the display unit displays celestial and/or terrestrial data to the user corresponding to the at least one coordinate entry.

The processor may be configured to determine directional information to a desired celestial or terrestrial location. The processor may be further configured to animate a space game relating to the desired celestial location. An input device operatively coupled to the processor and configured for entering data and commands may be used to enter an address of the desired celestial or terrestrial location. The device for viewing celestial and terrestrial data may also include an image stabilizer for stabilizing the display of celestial data from a rotation about a roll angle Ω. The display unit may display celestial data in real time and location or different time and/or location.

### DRAWINGS

The above-mentioned features and objects of the present disclosure will become more apparent with reference to the following description taken in conjunction with the accompanying drawings wherein like reference numerals denote like elements and in which:

FIG. 1 is a navigation system for providing celestial and terrestrial information, according to an embodiment of the invention.

FIG. 2 is an exemplary block diagram of the hardware architecture for the navigation system of FIG. 1.

FIG. 3 illustrates the display of celestial and terrestrial information in portrait mode, according to an embodiment of the invention.

FIG. 4 illustrates the display of celestial and terrestrial information in landscape mode, according to an embodiment of the invention.

FIG. 5 illustrates the display of celestial and terrestrial information at an angle with a displayed horizon maintained parallel to the true line of horizon, according to an embodiment of the invention.

FIG. 6 illustrates the display of directional information for a terrestrial location, according to an embodiment of the invention.

FIG. 7 illustrates the display of directional information for a celestial location, according to an embodiment of the invention.

FIG. 8 illustrates the display of descriptive information relating to a selected constellation, according to an embodiment of the invention.

### DETAILED DESCRIPTION

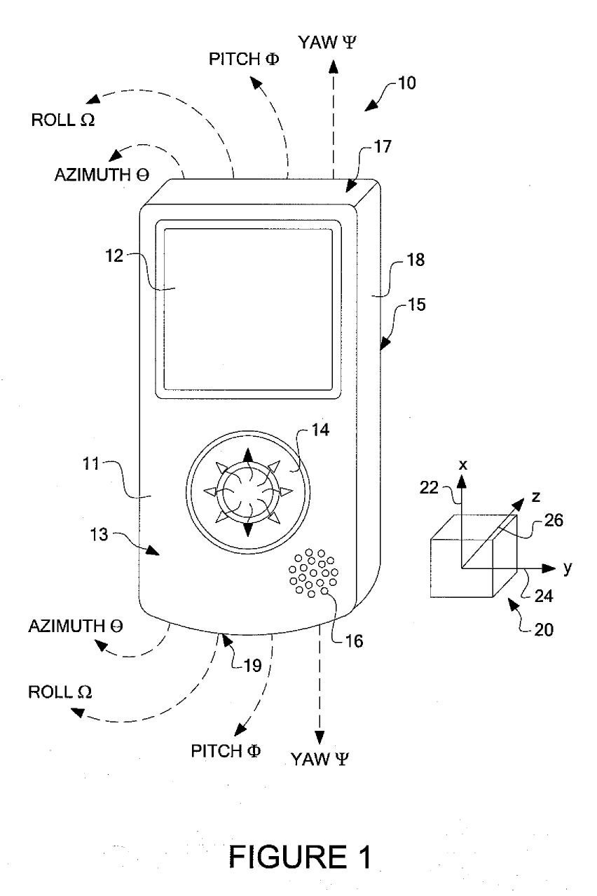

FIG. 1 is a navigation system 10 for providing celestial and terrestrial information, according to an embodiment of the invention. The navigation system 10 may include a housing 11, a display unit 12, an input device 14, a speaker 16, and internal hardware 18. The housing 11 has a front 13, a back 15, a top 17 and a bottom 19. The display unit 12 is configured to display celestial and/or terrestrial information. The input device 14 may be used to enter an address for obtaining directional information. The address may be a plurality of characters and/or numbers and/or symbols for identification of a celestial and terrestrial location. The speaker 16 may provide audio output containing directional or educational information relating to the celestial or terrestrial location.

The terrestrial information may be topographical, containing land object heights, such as, mountains and/or buildings. The terrestrial information may be displayed in two or three dimension. For example, two dimensional display may include geographical maps and/or satellite photos, while three dimensional display may include projections that, in perspective, have celestial objects appearing above land objects at an azimuth and an elevation corresponding to the true angles, as seen from the user's view point. The celestial information may be natural objects, such as stars, planets, sun, moon, comets, asteroids, and/or artificial objects, such as satellites. The celestial information may include points of interests, such as Zodiac constellations, Jupiter photos taken by Voyager, or Milky Way photos taken by the Hubble telescope. The speaker 16 may provide audio information on the points of interests, much like a celestial guided tour.

FIG. 1 illustrates an exemplary orientation of the navigation system 10 in relation to a reference axis 20. As shown in FIG. 1, the reference axis 20 may include an x-axis 22 in the vertical direction of the navigation system 10, a y-axis 24 in the lateral direction of the navigation system 10, and a z-axis 26 in the longitudinal direction of the navigation system 10. The movement of the navigation system 10 upwards or downwards along the x-axis 22 is the yaw or elevation ψ. The rotational movement of the navigation system 10 about the x-axis 22 is the azimuth φ, the rotational movement of the navigation system 10 about the y-axis 24 is the pitch Φ, and the rotational movement of the navigation system 10 about the z-axis 26 is the roll Ω.

The orientation of the navigation system 10, relative to the reference axis 20, determines which celestial and/or terrestrial information is/are displayed on the display unit 12. The azimuth φ, the pitch Φ, and/or the roll Ω may be utilized to determine the type of information displayed on the display unit 12. For example, the navigation system 10 may use the azimuth φ to display celestial and/or terrestrial objects behind the back 15 of the navigation system 10. The navigation system 10 will display terrestrial objects if the back 15 is facing land, celestial objects if the back 15 is facing sky, or celestial and terrestrial objects if the back 15 is facing the horizon.

In one embodiment, the navigation system 10 may be configured to allow selection of a viewing direction on the reference axis 20. The viewing direction may be selected along the x-axis 22, the y-axis 24 or the z-axis 26 direction. For example, if the z-axis 26 is selected, the celestial and/or terrestrial information displayed on the display unit 12 corresponds to the objects behind the back 15 of the navigation system 10. Hence, to see the line of the horizon displayed in the display unit 12, the user would keep the navigation system 10 aligned vertically. In contrast, if the x-axis 22 is selected, the celestial and/or terrestrial information displayed on the display unit 12 corresponds to the objects where the top 17 of the navigation system 10 points to. Hence, to see the line of the horizon displayed in the display unit 12, the user would keep the navigation system 10 aligned horizontally.

In another embodiment, the viewing direction for the reference axis 20 may be automatically selected. The navigation system 10 may be configured to automatically select the reference axis 20 to have an azimuth consistent and meaningful in any unit orientation of the navigation system 10. For example, the navigation system 10 may have an electronic magnetic compass that measures the heading (angle between the meridian and the projection on the horizontal plane for the reference axis 20) and an electronic level. The viewing direction for the reference axis 20 may be selected automatically based on predetermined conditions. For example, active application or application mode may be set to have viewing direction in the x-axis for outdoor or bike mode (predominantly horizontal) and z-axis for vehicle navigation application (predominantly vertical). The navigation system 10 may be configured to, for example, automatically select the viewing direction for the reference axis 20 by determining the condition of the navigation system 10, i.e. checking for presence of external power, or other cradle connections. The navigation system 10 may also be configured to, for example, automatically select the viewing direction for the reference axis 20 if the navigation system 10 is tilted less than a threshold angle from the horizon, for example, the viewing direction may be x-axis if the navigation system 10 is tilted less than 45 degrees, otherwise the viewing direction would be the z-axis. In one embodiment, the automatic or manual selection of the reference axis 20 may be presented to the user using visual or audio means.

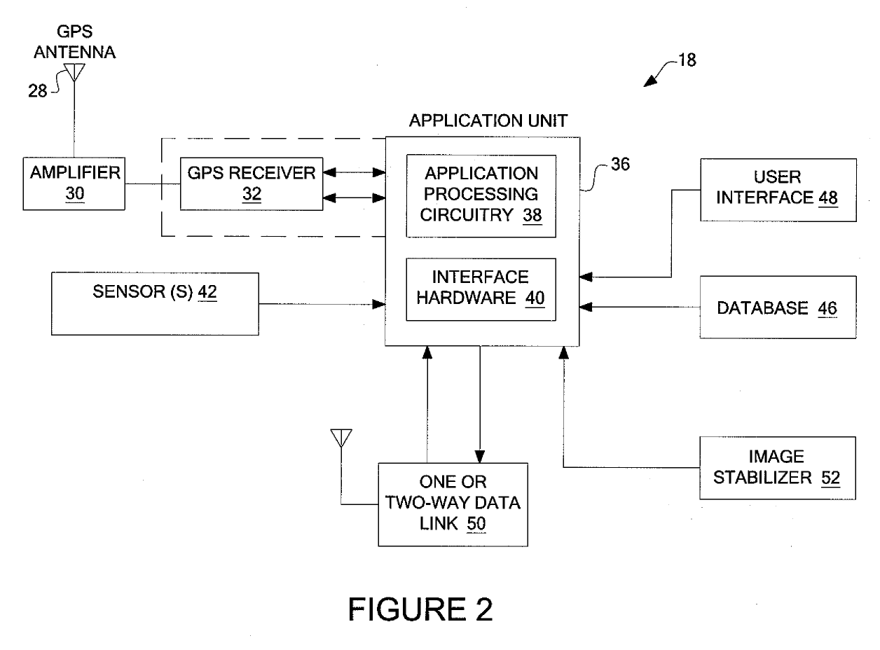

FIG. 2 is an exemplary block diagram of the hardware architecture 18 for the navigation system 10 of FIG. 1. In this embodiment, the hardware architecture 18 may include a GPS antenna 28, an amplifier 30, a GPS receiver 32, an application unit 36, one or more sensor(s) 42, a database 46, a user interface 48, a one or two-way communication link 50, and an image stabilizer 52.

The GPS antenna 28 may be used to receive GPS location signals. The GPS antenna 28 may be coupled to amplifier 30 that amplifies the GPS location signals received by the antenna 28. The amplifier 30 transmits the GPS location signals to the GPS receiver 32. In one embodiment, the amplifier 30 is optional, and the GPS antenna 28 connects directly to the GPS receiver 32. The GPS receiver 32 continuously determines the geographic position by measuring the ranges (the distance between a satellite with known coordinates in space and the GPS antenna 28) of several satellites and computing the geometric intersection of these ranges. To determine a range, GPS receiver 32 measures the time required for the GPS location signal to travel from the satellite to the GPS antenna 28. The GPS receiver 32 provides the GPS measurements to the application unit 36. The application unit 36 may include an application processing circuitry 38 and an interface hardware 40. The application processing circuitry 38 may include a processor, memory, busses, application software and related circuitry. In one embodiment, the application unit 36 may be incorporated into the GPS receiver 32.

The interface hardware 40 integrates various components of the navigation system 10 with the application unit 36. For example, the interface hardware 40 may be configured to integrate with sensor(s) 42, database 46, user interface 48, one or two-way data link 50, and image stabilizer 52.

The sensor(s) 42 may include magnetometer (magnetic compass), and gravity sensor (inclinometer or accelerometer). In one embodiment, one sensor 42 may be a direction (azimuth) sensor, such as a magnetometer, that equates the viewing direction of the navigation system 10 to the measurements obtained from the sensor 42, so that the displayed celestial and/or terrestrial information correspond to the land/sky objects where the viewing direction is directed to. Gravity sensor may be used to provide gravity measurements to determine the unit orientation (pitch and roll) relative to the horizon. In one embodiment, the gravity sensor equates the viewing elevation or pitch angle to the measurements obtained from the sensor, so that the displayed celestial and/or terrestrial information correspond to the land/sky objects where the viewing direction is directed to. In one embodiment, the navigation system 10 includes a direction (azimuth) sensor without a gravity sensor, allowing the user to manually select and/or scroll the elevation angle parameter. In another embodiment, the navigation system 10 includes a gravity sensor without a direction (azimuth) sensor, allowing the user to manually select and/or scroll the azimuth parameter. In one embodiment, the navigation system 10 includes a gravity sensor and a direction (azimuth) sensor, that equates the viewing direction (azimuth) and elevation angle to the measurements obtained from the sensors, so that the displayed celestial and/or terrestrial information correspond to the land/sky objects where the viewing direction is directed to.

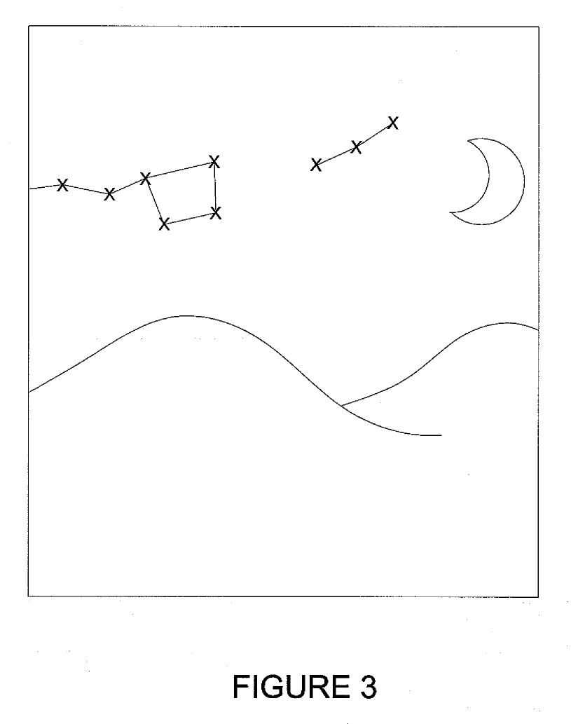

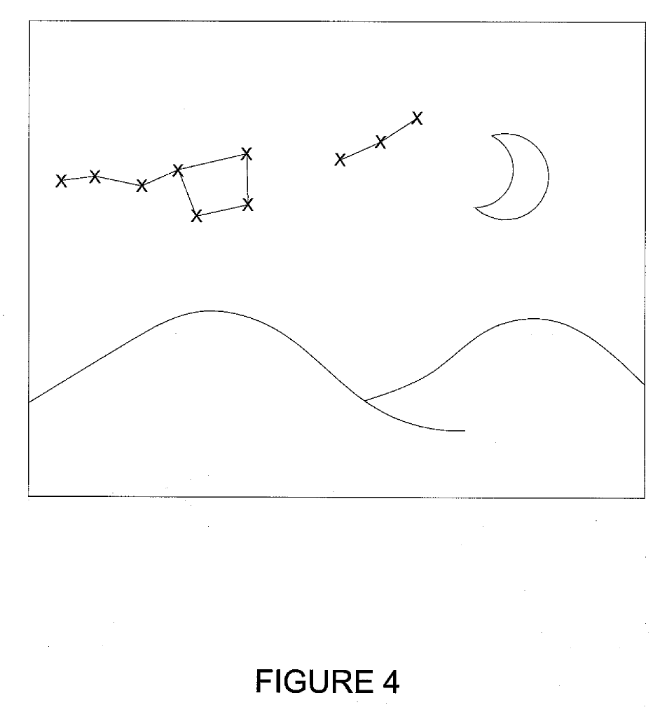

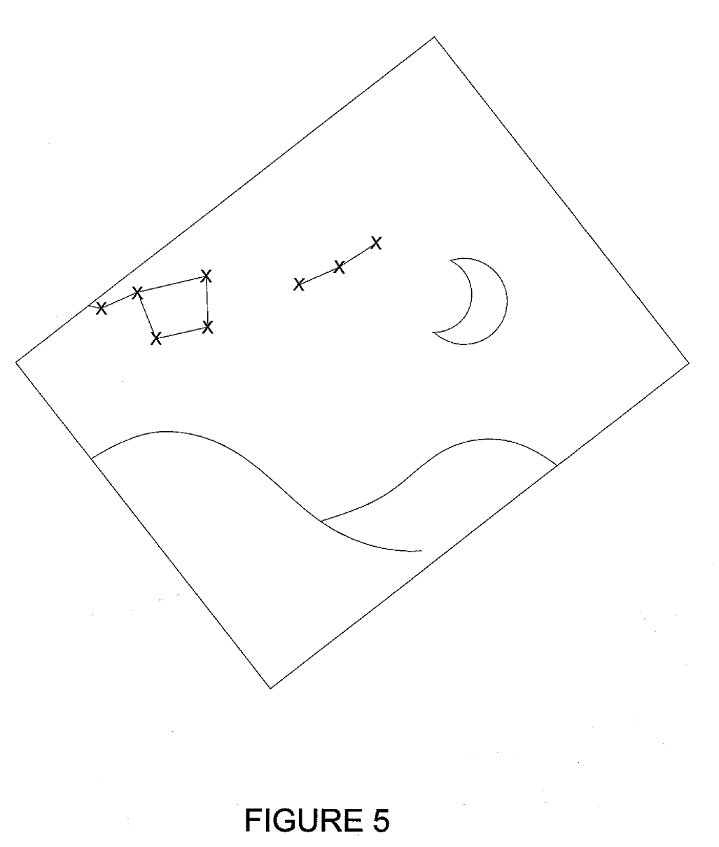

The database 46 stores celestial and terrestrial information and provides such information to the application unit 36. The database 46 may be updated, for example, using the internet, to include information on recent space discoveries/photos and on upcoming space events like meteorite showers, visible comets and/or asteroids. The user interface 32 may include the display unit 12, the input device 14 and the speaker 16. The user interface 32 allows interaction between the user and the navigation system 10. The one or two way communication link 50 facilitates communication with satellites to determine the directional information of a desired location. The image stabilizer 52 may be used to provide stabilization of the displayed celestial and/or terrestrial information in the roll Ω direction. Hence, if the viewing direction is directed to the horizon, the displayed horizon on the display unit 12 is substantially maintained parallel (leveled) to the true line of horizon, even if the navigation system 10 is rotated about the z-axis. As such, the display unit 12 can be used to display in portrait mode, landscape mode, or at an angle. FIG. 3 illustrates the display of celestial and terrestrial information in portrait mode. FIG. 4 illustrates the display of celestial and terrestrial information in landscape mode. FIG. 5 illustrates the display of celestial and terrestrial information at an angle with a displayed horizon maintained parallel to the true line of horizon.

According to one embodiment, the visible constellations and their location will depend on the user's location and the time at which the constellations are being displayed on the display unit 12. The navigation system 10 can display celestial and/or terrestrial information in real time and location. Using mapping technology known to a person skilled in the art, the navigation system 10 may be configured to allow the user to change the location and time. For example, the user can scroll through the screen/map to view constellations from Mount Everest or the Empire State Building without actually being there. The user can also scroll or change the viewing direction (azimuth and elevation angles). Another example, the navigation system 10 may be configured to animate celestial information displayed on the display unit 12, such that the user can select to view celestial and/or terrestrial information that would otherwise be visible at a certain time of the day. The navigation system 10 may be further configured to display and/or animate shadows at daytime, depending on the location of the sun and the time of the day. For example, the navigation system 10 determines the sunrise-sunset and moonrise-moonset times for the user's location and display shadows on the landscape accordingly. By taking the land topography into consideration, the displayed celestial objects and/or shadows from sunrise/sunset may be blocked by a hill or other terrestrial object in the way.

In one embodiment, the navigation system 10 may include zooming capability. It can be envisioned that at high zoom out level and user altitude, the display unit 12 may view the land map “out of space,” with a round Earth at the line of horizon.

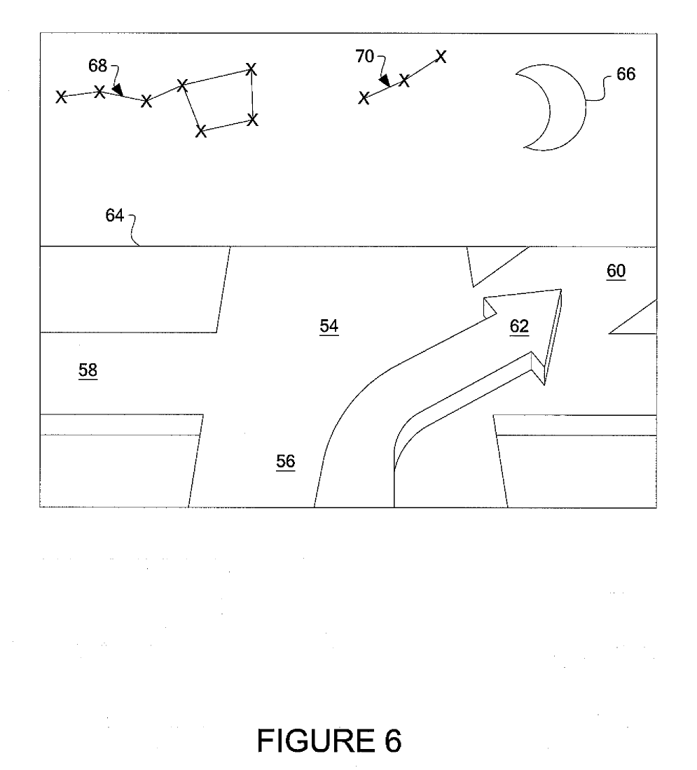

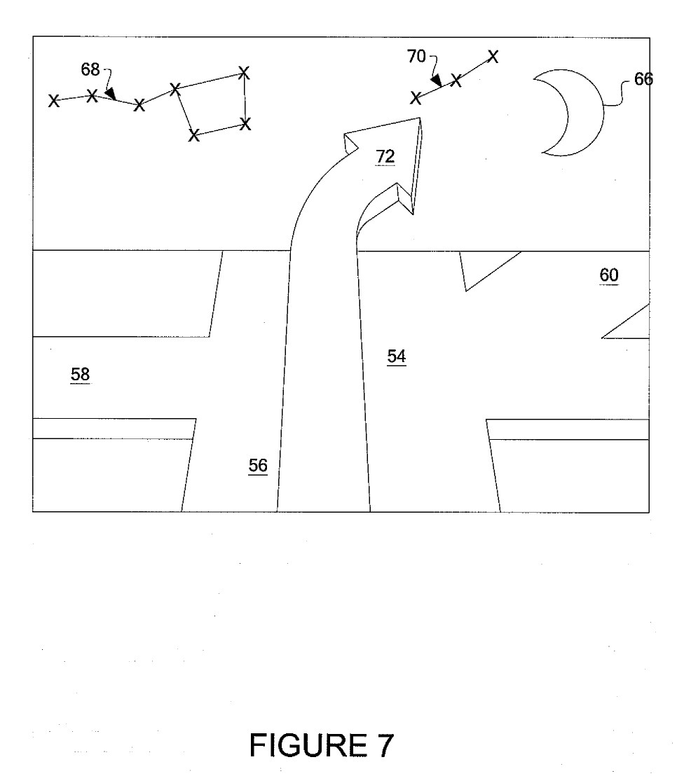

The navigation system 10 may be configured to provide directional information for a terrestrial or celestial location. FIG. 6 illustrates the display of directional information for a terrestrial location, while FIG. 7 illustrates the display of directional information for a celestial location. Providing directional information by measuring the distance between a satellite with known coordinates in space and the GPS antenna 28 and computing the travel directions to a desired location on a land map, is well known by a person skilled in the art. This may be further implemented in the navigation system 10 to provide directional information to a celestial object.

According to an embodiment of the invention, the navigation system 10 may be configured to have a search mode and/or a guidance mode. The search mode allows the user to use the orientation of the navigation system 10 as a control (viewfinder) to select an object on the land/sky map for display. The guidance mode allows the user to select terrestrial and/or celestial locations from the database 46 and compute directional information to the selected terrestrial and/or celestial locations.

The navigation system 10 may be configured to provide directional information for a terrestrial location while displaying celestial information. Likewise, the navigation system 10 may be configured to provide directional information for a celestial location while displaying terrestrial information. For example, in FIG. 6, a user approaching an intersection 54 between a first road 56, a second road 58, and a third road 60, is instructed to turn right 62 onto the third road 60. FIG. 6 illustrates a horizon 64 with a moon 66 and exemplary constellations: The Big Dipper 68 and Orion's Belt 70. FIG. 7 illustrates instructions 72 for locating Orion's Belt 70. The instructions 72 may include azimuth and elevation angle. Hence, the user may be instructed to turn right at a desired azimuth angle and alter the elevation angle, for example, by 20 degrees (i.e. change the pitch Φ of the navigation system 10).

In one embodiment, the navigation system 10 may be configured to allow the capturing/freezing of an image displayed on the display unit 12. This allows the user to place the navigation system 10 at any convenient position after the image is captured, zoom in and out of the displayed image, determine points of interests, legend and/or horoscope, and begin the celestial guided audio tour.

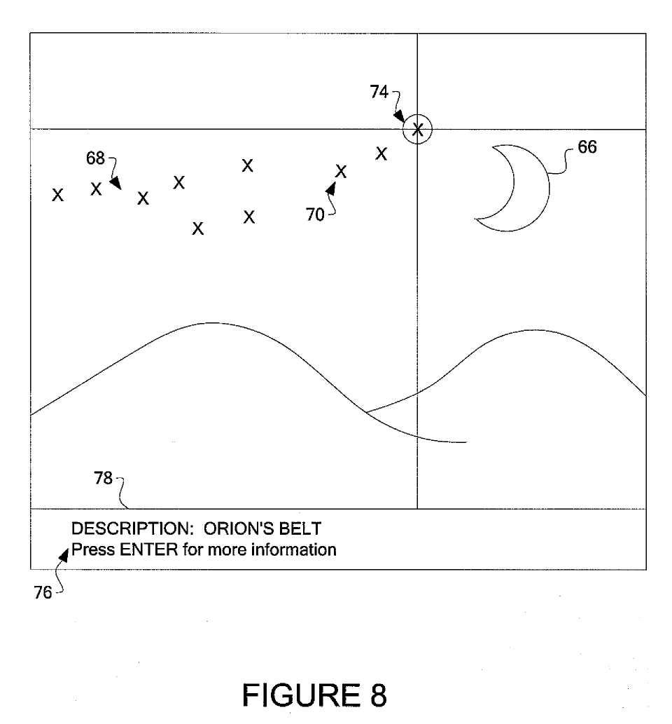

FIG. 8 illustrates the display of descriptive information relating to a selected constellation. According to an embodiment of the invention, the navigation system 10 may be configured to allow the user to select a displayed terrestrial or celestial object for obtaining descriptive information. The user can use the input device 14 to move a cursor 74 to a desired location and press ENTER to obtain descriptive information. For example, as shown in FIG. 8, the user can move the cursor 74 to the Orion's Belt 70. The display unit 12 may display descriptive information 76 at a predetermined location 78 for the user to read and/or scroll through while viewing the selected image. In one embodiment, the selection of the displayed terrestrial or celestial object forwards the user to another screen with detailed information about the selected object.

While certain exemplary embodiments have been described and shown in the accompanying drawings, it is to be understood that such embodiments are merely illustrative of and not restrictive of the broad invention, and that this invention not be limited to the specific constructions and arrangements shown and described, since various other changes, combinations, omissions, modifications and substitutions, in addition to those set forth in the above paragraphs, are possible.

For example, the navigation system 10 may be adapted to automatically select an object displayed in the middle of the display unit 12. The navigation system 10 may allow the selection of terrestrial or celestial objects from the database 46 while displaying the map with the object in the middle, along with the display of the object's azimuth and elevation. The navigation system 10 may be adapted to display view point location, time for which the celestial information is displayed, view direction, and/or zoom level. The navigation system 10 may further be configured to provide the selected object's name, location, visibility and other information by text, audio and/or video means, including narration and photos of the object. It can be envisioned that the user can enter name, date-of-birth and other horoscope-related inputs, and the navigation system 10 will display user's Zodiac constellation, relevant planets, with the horoscope and other fortune-telling information presented by text, audio and/or video. The navigation system 10 may be adapted to allow a user to highlight a celestial group consisting of more then one celestial object, such as a constellation, and draw the symbolic (mythological) constellation shape, as shown in FIGS. 3-8. The navigation system 10 may further provide information for each celestial object of the constellation.

In one embodiment, the navigation system 10 may include one or more video games, such as Star Wars, with a route determined from a land point to a space destination. For example, a user may select a constellation, such as The Big Dipper 68, as the space destination, using the search more or guidance mode. The application processing circuitry 38 may formulate a space route from the user's location or another predetermined location to the selected space destination. It can be envisioned that the formulated space route may include predetermined obstacles or game levels with increasing difficulty and intensity.

Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A navigation system, comprising:
a housing;
a GPS receiver disposed in the housing and configured to receive a GPS location signal;
a database disposed in the housing and containing celestial data;
a processor operatively coupled to the GPS receiver and the database, the processor determining a user's location from the GPS location signal;
a sensor operatively coupled to the processor and contained in the housing, the sensor is adapted to provide the processor with a rotational angle representing the orientation of the housing; and
a display unit operatively coupled to the processor, the display unit displaying the celestial data to the user corresponding to the rotational angle of the housing.

2. The navigation system of claim 1, wherein the database contains terrestrial data.

3. The navigation system of claim 2, wherein the processor is configured to determine directional information to a desired terrestrial location.

4. The navigation system of claim 1, wherein the processor is configured to determine directional information to a desired celestial location.

5. The navigation system of claim 1, wherein the rotational angle is selected from a group consisting of an azimuth φ, a pitch Φ, or a roll Ω.

6. The navigation system of claim 1, wherein the sensor is selected from a group consisting of a magnetometer, inclinometer and accelerometer.

7. The navigation system of claim 1, further comprising an image stabilizer for stabilizing the display of celestial data from a rotation about a roll angle Ω.

8. The navigation system of claim 1, wherein the display unit displays celestial data in real time and location.

9. The navigation system of claim 1, wherein the processor is configured to allow selection of at least one parameter selected from a group consisting of location and time, the selection of the parameter allows the user to display corresponding celestial data.

10. The navigation system of claim 1, further comprising a speaker for providing audio related to the celestial data displayed.

11. The navigation system of claim 1, wherein the processor is configured to animate a space game relating to a desired celestial location.

12. A device for viewing celestial and terrestrial data, comprising:
a housing having a reference axis;
a database disposed in the housing and containing celestial and terrestrial data;
a GPS receiver operatively coupled to the database, the GPS receiver is configured to receive a GPS signal;
a processor operatively coupled to the GPS receiver and the database, the processor is contained in the housing and configured to determine a user's location from the GPS signal;
a sensor operatively coupled to the processor, the sensor is adapted to provide the processor with a rotational angle representing the orientation of the housing relative to the reference axis; and
a display unit operatively coupled to the processor, the display unit displays data to the user corresponding to the rotational angle of the housing, the data is selected from a group consisting of celestial data, terrestrial data and combinations thereof.

13. The device for viewing celestial and terrestrial data of claim 12, further comprising an input device operatively coupled to the processor, the input device is configured for entering data and commands.

14. The device for viewing celestial and terrestrial data of claim 12, wherein the processor is configured to determine directional information to a desired terrestrial location.

15. The device for viewing celestial and terrestrial data of claim 12, wherein the processor is configured to determine directional information to a desired celestial location.

16. The device for viewing celestial and terrestrial data of claim 12, wherein the rotational angle is selected from a group consisting of an azimuth φ, a pitch Φ, or a roll Ω.

17. The device for viewing celestial and terrestrial data of claim 12, wherein the sensor is selected from a group consisting of a magnetometer, inclinometer and accelerometer.

18. The device for viewing celestial and terrestrial data of claim 12, further comprising an image stabilizer for stabilizing the display of data from a rotation about a roll angle Ω.

19. The device for viewing celestial and terrestrial data of claim 12, wherein the reference axis is selected by the user or automatically.

20. The device for viewing celestial and terrestrial data of claim 12, wherein the display unit displays data based on at least one parameter selected from a group consisting of real location, real time, and combinations thereof.

21. The device for viewing celestial and terrestrial data of claim 12, wherein the processor is configured to allow selection of at least one parameter selected from a group consisting of location and time, the selection of the parameter allows the user to display corresponding data.

22. The device for viewing celestial and terrestrial data of claim 12, further comprising a speaker for providing audio related to the celestial data displayed.

23. The device for viewing celestial and terrestrial data of claim 12, wherein the processor is configured to animate a space game relating to a desired celestial location.

24. A device for viewing celestial and terrestrial data, comprising:
a database containing celestial and terrestrial data;
a processor operatively coupled to the database, the processor is configured to determine celestial and terrestrial data corresponding to at least one coordinate entry;
an input device operatively coupled to the processor, the input device provides an interface for inputting the at least one coordinate entry; and
a display unit operatively coupled to the processor, the display unit displays data to the user corresponding to the at least one coordinate entry, the data is selected from a group consisting of celestial data, terrestrial data and combinations thereof.
